(19) United States
(12) Patent Application Publication
(10) Pub. No.: US 2010/0255185 A1
(43) Pub. Date: Oct. 7, 2010

(54) METHOD FOR THE PRODUCTION OF A CONDUCTIVE POLYCARBONATE COMPOSITES

(75) Inventors: Stefan Bahnmueller, Singapore (SG); Andreas Greiner, Amoeneburg (DE); Markus Schackmann, Niederweimar (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/746,315

(22) PCT Filed: Nov. 25, 2008
(86) PCT No.: PCT/EP08/09969

§ 371 Date: Jun. 4, 2010

(30) Foreign Application Priority Data
Dec. 7, 2007 (DE) 10 2007 058 992.3

(51) Int. Cl. B05D 5/12; H01B 1/12

(52) U.S. Cl. 427/113; 252/500; 977/748

(57) ABSTRACT

The invention relates to a method for the production of an electrically conductive polycarbonate composite on the basis of thermoplastic polycarbonate and carbon nanotubes, wherein acid-functionalized carbon nanotubes are dispersed with molten polycarbonate.

The invention relates to a process for the preparation of an electrically conductive polycarbonate composite material based on thermoplastic polycarbonate and carbon nanotubes, in which acid-functionalized carbon nanotubes are dispersed with molten polycarbonate. In the following, the carbon nanotubes are also optionally abbreviated to CNT.

Carbon nanotubes have a large number of exceptional properties based both on their chemical structure of highly crystalline carbon and on the large surface area thereof.

According to the prior art, carbon nanotubes are understood as meaning chiefly cylindrical carbon tubes with a diameter of between 3 and 100 nm and a length which is several times the diameter. These tubes comprise one or more layers of ordered carbon atoms and have a core of differing morphology. These carbon nanotubes are also called, for example, “carbon fibrils” or “hollow carbon fibres”.

Carbon nanotubes have been known for a long time in the technical literature. Although Iijima (publication: S. Iijima, Nature 354, 56-58, 1991) is generally named as the discoverer of nanotubes, these materials, in particular fibrous graphite materials with several layers of graphite, have already been known since the 70s and early 80s. Tates and Baker (GB 1469930A1, 1977 and EP 56004 A2) described for the first time the deposition of very fine fibrous carbon from the catalytic decomposition of hydrocarbons. However, the carbon filaments produced on the basis of short-chain hydrocarbons are not characterized in more detail with respect to their diameter.

Conventional structures of these carbon nanotubes are those of the cylinder type. Among the cylindrical structures, a distinction is made between the single-wall mono-carbon nanotubes (single wall carbon nanotubes) and the multi-wall cylindrical carbon nanotubes (multi wall carbon nanotubes). The usual processes for their production are e.g. arc processes (arc discharge), laser ablation, chemical deposition from the vapour phase (CVD process) and catalytic chemical deposition from the vapour phase (CCVD process).

Iijima, Nature 354, 1991, 56-8 discloses the formation, in the arc process, of carbon tubes which comprise two or more graphene layers and are rolled up to a cylinder closed without seams and inserted into one another. Depending on the rolling vector, chiral and achiral arrangements of the carbon atoms in relation to the longitudinal axis of the carbon fibres are possible.

Structures of carbon tubes in which an individual continuous graphene layer (so-called scroll type) or interrupted graphene layer (so-called onion type) is the basis for the construction of the nanotubes were described for the first time by Bacon et al., J. Appl. Phys. 34, 1960, 283-90. The structure is called scroll type. Corresponding structures were later also found by Zhou et al., Science, 263, 1994, 1744-47 and by Lavin et al., Carbon 40, 2002, 1123-30. However, the high degree of surface activity of the CNT has the following disadvantage: The CNT form aggregates which are very stable mechanically, the size of which is in the micrometre range and the bonding of which can be broken down again only with difficulty. There has therefore been no lack of attempts to date to solve the problems of deaggregation of CNT in a liquid or polymeric matrix.

Xiao-Lin Xie, Yiu-Wing Mai and Xing-Ping Zhou describe in their review article of 2005 in “Materials Science and Engineering R 49, 89-112” the priority of deaggregation or the avoidance of aggregation, and good dispersion of carbon nanotubes. The common methods of compounding for the preparation of polymers with a conventional filler content is the simplest way of replacing microscale fillers by nanoscale fillers and of producing high performance polymers. However, the dispersing of nanofillers into the polymer matrix is much more difficult due to the marked tendency towards aggregation. To improve the dispersing of polymer/CNT composites, high performance dispersing methods, such as the ultrasound technique and high speed shearing units, are employed. It is often carried out in solution, so that the use of ultrasound is possible.

Hilding, Grulke, Zhang and Lockwood describe in the review of 2003 in “Journal of Dispersion Science and Technology, vol. 24, no. 1, pp. 1-41, 2003” the dispersibility of nanotubes in liquids and the importance of homogenization. In the production process for carbon nanotubes, a mixture of different morphologies which are mechanically tangled or aggregated is formed. Aggregated nanoparticles must often be suspended in liquids for development of materials with exceptional mechanical properties.

The authors of the review: “Polymer Nanocomposites Containing Carbon Nanotubes, Macromolecules 2006, 39, 5194-5205”, Moniruzzaman and Winey, describe very comprehensively the current prior art at that time for producing nanocomposites with carbon nanotubes and the importance of homogeneity.

The object of the invention is to develop a process for production of a polycarbonate-CNT composite material in which as many isolated CNT as possible are present, by which means the mechanical and electrical properties of polymer composite materials obtainable therefrom can be improved. It is a further object to produce CNT material in which isolated CNT and as few agglomerates and aggregates of CNT as possible are present. Agglomerates and aggregates are understood as meaning accumulations of small particles (here CNT fibres) which contain a large number of particles which are bonded physically and/or chemically to one another. Agglomerates can be broken down into individual particles during dispersion more easily than aggregates.

It has been found that by chemical grafting of polycarbonate molecules on to the surface of acid-functionalized CNT, deaggregation during mixing of the materials is possible to a high degree and reaggregation of the CNT can be largely prevented.

The invention provides a process for the preparation of a conductive carbon nanotube-polycarbonate composite material, characterized in that in a first step carbon nanotubes are treated with an oxidizing agent to form acid groups on the CNT, in that in a second step the acid-functionalized CNT are mixed with polycarbonate and a transesterification catalyst, and in a third step the mixture is melted and exposed to shearing forces,

The oxidizing agent used is preferably an oxidizing agent from the series: nitric acid, hydrogen peroxide, potassium permanganate and sulfuric acid or a possible mixture of these agents. Preferably, nitric acid or a mixture of nitric acid and sulfuric acid, particularly preferably nitric acid, is used.

All Lewis acids and weak Brönsted acids are in principle suitable for catalysis of the transesterification. The ligands should preferably have σ-π donor properties.

The transesterification catalyst used for the coupling of the polycarbonate is preferably a transesterification catalyst which is chosen from the series titanium tetrabutanolate, BF₃, AlCl₃, SiCl₄, PF₅, Ti⁴⁺, Cr³⁺, Fe³⁺, Cu²⁺, SiF₄ and Na⁺.

Particular advantages are achieved if the mixing, melting and exposure to shearing forces of the components acid-functionalized CNT, polycarbonate and transesterification catalyst in the second and third step take place in one reaction space.

Further advantages emerge in a further preferred process if the exposure to shearing forces in the third step proceeds at a temperature which is at most 100° C., preferably at most 80° C. above the glass transition temperature of the polycarbonate.

Carbon nanotubes in the context of the invention are all single-wall or multi-wall carbon nanotubes of the cylinder type, scroll type or with an onion-type structure. Multi-wall carbon nanotubes of the cylinder type, scroll type or mixtures thereof are preferably to be employed.

The carbon nanotubes are employed in particular in an amount of from 0.01 to 10 wt. %, preferably 0.1 to 5 wt. %, based on the mixture of polymer and carbon nanotubes in the finished compound. In masterbatches, the concentration of the carbon nanotubes is optionally higher.

Particularly preferably, carbon nanotubes with a ratio of length to external diameter of greater than 5, preferably greater than 100 are used.

The carbon nanotubes are particularly preferably employed in the form of agglomerates, the agglomerates having, in particular, an average diameter in the range of from 0.05 to 5 mm, preferably 0.1 to 2 mm, particularly preferably 0.2-1 mm.

The carbon nanotubes to be employed particularly preferably essentially have an average diameter of from 3 to 100 mm, preferably 5 to 80 nm, particularly preferably 6 to 60 nm.

In contrast to the abovementioned known CNT of the scroll type with only one continuous or interrupted graphene layer, CNT structures which comprise several graphene layers which are combined into a stack and rolled up (multi-scroll type) have also been found by the applicant. These carbon nanotubes and carbon nanotube agglomerates therefrom are the subject matter, for example, of the still unpublished

German patent application with the application number 10 2007 044 031.8. The content thereof is also included herewith in the disclosure content of this application with respect to the CNT and their production. This CNT structure bears a relationship to the carbon nanotubes of the simple scroll type comparable to that of the structure of multi-walled cylindrical mono-carbon nanotubes (cylindrical MWNT) to the structure of singe-walled cylindrical carbon nanotubes (cylindrical SWNT).

In contrast to the onion-type structures, the individual graphene or graphite layers in these carbon nanotubes, viewed in cross-section, evidently run continuously from the centre of the CNT to the outer edge without interruption. This can make possible e.g. an improved and faster intercalation of other materials in the tube skeleton, since more open edges are available as an entry zone for the intercalates compared with CNT with a simple scroll structure (Carbon 34, 1996, 1301-3) or CNT with an onion-type structure (Science 263, 1994, 1744-7).

The methods known at present for the production of carbon nanotubes include arc, laser ablation and catalytic methods. In many of these methods, carbon black, amorphous carbon and fibres having a high diameter are formed as by-products. In the catalytic processes, a distinction may be made between deposition on supported catalyst particles and deposition on metal centres formed in situ and having diameters in the nanometre range (so-called flow process). In the case of production via catalytic deposition of carbon from hydrocarbons which are gaseous under the reaction conditions (in the following CCVD; catalytic carbon vapour deposition), acetylene, methane, ethane, ethylene, butane, butene, butadiene, benzene and further carbon-containing educts are mentioned as possible carbon donors. CNT obtainable from catalytic processes are therefore preferably employed.

The catalysts as a rule contain metals, metal oxides or decomposable or reducible metal components. For example, Fe, Mo, Ni, V, Mn, Sn, Co, Cu and further sub-group elements are mentioned in the prior art as metals for the catalyst. The individual metals usually indeed have a tendency to assist in the formation of carbon nanotubes, but according to the prior art high yields and low contents of amorphous carbons are advantageously achieved with those metal catalysts which are based on a combination of the abovementioned metals. CNT obtainable using mixed catalysts are consequently preferably to be employed.

Particularly advantageous catalyst systems for the production of CNT are based on combinations of metals or metal compounds which contain two or more elements from the series Fe, Co, Mn, Mo and Ni.

Experiences shows that the formation of carbon nanotubes and the properties of the tubes formed depend in a complex manner on the metal component used as the catalyst or a combination of several metal components, the catalyst support material optionally used and the interaction between the catalyst and support, the educt gas and its partial pressure, admixing of hydrogen or further gases, the reaction temperature and the dwell time and the reactor used.

A process which is particularly preferably to be employed for the production of carbon nanotubes is known from WO 2006/050903 A2.

In the various processes mentioned so far employing various catalyst systems, carbon nanotubes of various structures are produced, which can be removed from the process predominantly as carbon nanotube powder.

Carbon nanotubes which are further preferably suitable for the invention are obtained by processes which are described in principle in the following literature references:

The production of carbon nanotubes having diameters of less than 100 nm is described for the first time in EP 205 556 B1. Light (i.e. short- and medium-chain aliphatic or mono- or dinuclear aromatic) hydrocarbons and a catalyst based on iron, on which carbon support compounds are decomposed at a temperature above 800-900° C., are employed here for the production.

WO 86/03455 A1 describes the production of carbon filaments which have a cylindrical structure with a constant diameter of from 3.5 to 70 nm, an aspect ratio (ratio of the length to the diameter) of greater than 100 and a core region. These fibrils are made of many continuous layers of ordered carbon atoms arranged concentrically around the cylindrical axis of the fibrils. These cylinder-like nanotubes have been produced by a CVD process from carbon-containing compounds by means of a metal-containing particle at a temperature of between 850° C. and 1,200° C.

WO 2007/093337 A2 has also disclosed a process for the preparation of a catalyst which is suitable for the production of conventional carbon nanotubes with a cylindrical structure. When this catalyst is used in a fixed bed, relatively high yields of cylindrical carbon nanotubes with a diameter in the range of from 5 to 30 nm are obtained.

A completely different route for the production of cylindrical carbon nanotubes has been described by Oberlin, Endo and Koyam (Carbon 14, 1976, 133). In this, aromatic hydrocarbons, e.g. benzene, are reacted on a metal catalyst. The carbon tubes formed shows a well-defined, graphitic hollow core which has approximately the diameter of the catalyst particle and on which further, less graphitically arranged carbon is found. The entire tube can be graphitized by treatment at a high temperature (2,500° C.-3,000° C.).

Most of the abovementioned processes (with arc, spray pyrolysis or CVD) are used at present for the production of carbon nanotubes. However, the production of single-wall cylindrical carbon nanotubes is very expensive in terms of apparatus and proceeds with a very low rate of formation by the known processes, and often also with many side reactions, which lead to a high content of undesirable impurities, i.e. the yield of such processes is comparatively low. The production of such carbon nanotubes is therefore also still extremely expensive industrially at present, and they are therefore employed above all in small amounts for highly specialized uses. However, their use for the invention is conceivable, but less preferred than the use of multi-wall CNT of the cylinder or scroll type.

The production of multi-wall carbon nanotubes in the form of seamless cylindrical nanotubes inserted into one another or also in the form of the scroll or onion structures described is at present carried out commercially in relatively large amounts predominantly using catalytic processes. These processes conventionally show a higher yield than the abovementioned arc and other processes and are at present typically carried out on the kg scale (a few hundred kilos/day worldwide). The MW carbon nanotubes produced in this way are as a rule somewhat less expensive that the single-all nanotubes and are therefore employed e.g. as a performance-increasing additive in other materials.

Possible polycarbonates for carrying out the process are preferably in principle the types mentioned below or mentioned in the following processes for the preparation of polycarbonate.

The polycarbonates according to the invention are prepared by the interfacial process. This process for polycarbonate synthesis is described in many instances in the literature; reference may be made by way of example to H Schnell, Chemistry and Physics of Polycarbonates, Polymer Reviews, vol. 9, Interscience Publishers, New York 1964 p. 33 et seq., to Polymer Reviews, vol. 10, “Condensation Polymers by Interfacial and Solution Methods”, Paul W Morgan, Interscience Publishers, New York 1965, chap. VIII, p. 325, to Dres. U. Grigo, K. Kircher and P. R. Muller “Polycarbonate” in Becker/Braun, Kunststoff-Handbuch, volume 3/1, Polycarbonate, Polyacetale, Polyester, Celluloseester, Carl Hanser Verlag Munich, Vienna 1992, p. 118-145 and to EP-A 0 517 044.

According to this process, the phosgenation of a disodium salt, initially introduced in aqueous alkaline solution (or suspension), of a bisphenol (or of a mixture of various bisphenols) is carried out in the presence of an inert organic solvent or solvent mixture which forms a second phase. The oligocarbonates formed, which are chiefly present in the organic phase, undergo condensation with the aid of suitable catalysts to give high molecular weight polycarbonates dissolved in the organic phase. The organic phase is finally separated off and the polycarbonate is isolated therefrom by various working up steps.

Dihydroxyaryl compounds which are suitable for the preparation of polycarbonates are those of the formula (2)

HO—Z—OH (2)

in which
Z is an aromatic radical having 6 to 30 C atoms, which can contain one or more aromatic nuclei, can be substituted and can contain aliphatic or cycloaliphatic radicals or alkylaryls or hetero atoms as bridge members.

Preferably, in formula (2) Z represents a radical of the formula (3)

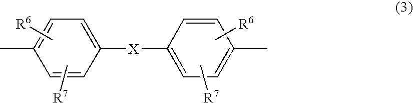

in which
R⁶ and R⁷ independently of one another represent H, C₁-C₁₈-alkyl, C₁-C₁₈-alkoxy, halogen, such as Cl or Br, or in each case optionally substituted aryl or aralkyl, preferably H or C₁-C₁₂-alkyl, particularly preferably H or C₁-C₈-alkyl and very particularly preferably H or methyl, and
X represents a single bond, —SO₂—, —CO—, —O—, —S—, to C₆-alkylene, C₂- to C₅-alkylidene or C₅- to C₆-cycloalkylidene, which can be substituted by C₁- to C₆-alkyl, preferably methyl or ethyl, or furthermore represents C₆- to C₁₂-arylene, which can optionally be condensed with further aromatic rings containing hetero atoms.

Preferably, X represents a single bond, C₁ to Cₛ-alkylene, C₂ to C₅-alkylidene, C₅ to C₆-cycloalkylidene, —O—, —SO—, —CO—, —S—, —SO₂—,

or a radical of the formula (3a) or (3b)

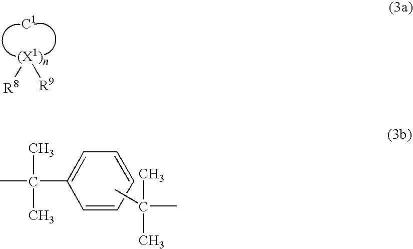

wherein
R⁸ and R⁹ can be chosen individually for each X¹ and independently of one another denote hydrogen or C₁ to C₆-alkyl, preferably hydrogen, methyl or ethyl,
X′ denotes carbon and
n denotes an integer from 4 to 7, preferably 4 or 5, with the proviso that on at least one atom X¹ R⁸ and R⁹ are simultaneously alkyl.

Examples of dihydroxyaryl compounds are dihydroxybenzenes, dihydroxydiphenyls, bis-(hydroxyphenyl)-alkanes, bis-(hydroxyphenyl)-cycloalkanes, bis-(hydroxyphenyl)-aryls, bis-(hydroxyphenyl) ethers, bis-(hydroxyphenyl) ketones, bis-(hydroxyphenyl) sulfides, bis-(hydroxyphenyl) sulfones, bis-(hydroxyphenyl) sulfoxides, 1,1′-bis-(hydroxyphenyl)-diisopropylbenzenes and nucleus-alkylated and nucleus-halogenated compounds thereof.

Diphenols which are suitable for the preparation of the polycarbonates to be used according to the invention are, for example, hydroquinone, resorcinol, dihydroxydiphenyl, bis-(hydroxyphenyl)-alkanes, bis-(hydroxyphenyl)-cycloalkanes, bis-(hydroxyphenyl) sulfides, bis-(hydroxyphenyl) ethers, bis-(hydroxyphenyl) ketones, bis-(hydroxyphenyl) sulfones, bis-(hydroxyphenyl) sulfoxides, α,α′-bis-(hydroxyphenyl)-diisopropylbenzenes, and alkylated, nucleus-alkylated and nucleus-halogenated compounds thereof.

Preferred diphenols are 4,4′-dihydroxydiphenyl, 2,2-bis-(4-hydroxyphenyl)-1-phenylpropane, 1,1-bis-(4-hydroxyphenyl)-phenylethane, 2,2-bis-(4-hydroxyphenyl)-propane, 2,4-bis-(4-hydroxyphenyl)-2-methylbutane, 1,3-bis-[2-(4-hydroxyphenyl)-2-propyl]-benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl) sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene and 1,1-bis-(4-hydroxyphenyl)-3,3,5-trimethylcyclohexane (bisphenol TMC).

Particularly preferred diphenols are 4,4′-dihydroxydiphenyl, 1,1-bis-(4-hydroxyphenyl)-phenylethane, 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC).

These and further suitable diphenols are described e.g. in U.S. Pat. Nos. 2,999,835, 3,148,172, 2,991,273, 3,271,367, 4,982,014 and 2,999,846, in the German Offenlegungsschriften 1 570 703, 2 063 050, 2 036 052, 2 211 956 and 3 832 396, French Patent Specification 1 561 518, in the monograph “H. Schnell, Chemistry and Physics of Polycarbonates, Interscience Publishers, New York 1964, p. 28 et seq.; p. 102 et seq.”, and in “D. G. Legrand, J. T. Bendler, Handbook of Polycarbonate Science and Technology, Marcel Dekker New York 2000, p. 72 et seq.”.

In the case of homopolycarbonates only one diphenol is employed, and in the case of copolycarbonates two or more diphenols are employed. The diphenols used, like all the other chemicals and auxiliary substances added to the synthesis, may be contaminated with impurities originating from their own synthesis, handling and storage. However, it is desirable to work with raw materials which are as pure as possible.

The monofunctional chain terminators required for regulation of the molecular weight, such as phenol or alkylphenols, in particular phenol, p-tert-butylphenol, iso-octylphenol, cumylphenol, chlorocarbonic acid esters thereof or acid chlorides of monocarboxylic acids or mixture of these chain terminators, either are fed to the reaction with the bisphenolate or the bisphenolates, or are added at any desired point in time of the synthesis, as long as phosgene or chlorocarbonic acid end groups are still present in the reaction mixture or, in the case of the acid chlorides and chlorocarbonic acid esters as chain terminators, as long as sufficient phenolic end groups of the polymer forming are available. Preferably, however, the chain terminator or terminators are added after the phosgenation at a site or at a point in time where phosgene is no longer present, but the catalyst has not yet been metered in, or they are metered in before the catalyst, together with the catalyst or parallel therewith.

In the same manner, any branching agents or branching agent mixtures to be used are added to the synthesis, but conventionally before the chain terminators. Trisphenols, quaternary phenols or acid chlorides of tri- or tetracarboxylic acids are conventionally used, or also mixtures of the polyphenols or of the acid chlorides.

Some of the compounds with three or more than three phenolic hydroxyl groups which can be used are, for example,
phloroglucinol,
4,6-dimethyl-2,4,6-tri-(4-hydroxyphenyl)-hept-2-ene,
4,6-dimethyl-2,4,6-tri-(4-hydroxyphenyl)-heptane,
1,3,5-tri-(4-hydroxyphenyl)-benzene,
1,1,1-tri-(4-hydroxyphenye-ethane,
tri-(4-hydroxyphenyl)-phenylmethane,
2,2-bis-(4,4-bis-(4-hydroxyphenyl)-cyclohexyl]-propane,
2,4-bis-(4-hydroxyphenyl-isopropyl)-phenol,
tetra-(4-hydroxyphenyl)-methane.

Some of the other trifunctional compounds are 2,4-dihydroxybenzoic acid, trimeric acid, cyanuric chloride and 3,3-bis-(3-methyl-4-hydroxyphenyl)-2-oxo-2,3-dihydroindole.

Preferred branching agents are 3,3-bis-(3-methyl-4-hydroxyphenyl)-2-oxo-2,3-dihydroindole and 1,1,1-tris-(4-hydroxyphenyl)-ethane.

The catalysts used in the interfacial synthesis are tertiary amines, in particular triethylamine, tributylamine, trioctylamine, N-ethylpiperidine, N-methylpiperidine or N-i/n-propylpiperidine; quaternary ammonium salts, such as tetrabutylammonium/tributylbenzylammonium/tetraethylammonium hydroxide/chloride/bromide/hydrogen sulfate/tetrafluoroborate; and the phosphonium compounds corresponding to the ammonium compounds. These compounds are described in the literature as typical interfacial catalysts, and are commercially obtainable and familiar to the person skilled in the art. The catalysts can be added to the synthesis individually, in a mixture or also side by side and successively, optionally also before the phosgenation, but metering in after the introduction of phosgene are preferred, unless an onium compound or mixtures of onium compounds are used as the catalyst. Addition before metering in the phosgene is then preferred. Metering in of the catalyst or catalysts can be carried out in substance, in an inert solvent, preferably that of the polycarbonate synthesis, or also as an aqueous solution, in the case of the tertiary amines then as ammonium salts thereof with acids, preferably mineral acids, in particular hydrochloric acid. If several catalysts are used or part amounts of the total amount of the catalyst are metered in, it is of course also possible to carry out different methods of metering in at various sites or various times. The total amount of catalysts used is between 0.001 to 10 mol %, based on the moles of bisphenols employed, preferably 0.01 to 8 mol %, particularly preferably 0.05 to 5 mol %.

The conventional additives for polycarbonates can also be added to the polycarbonates according to the invention in the conventional amounts. The addition of additives serves to prolong the duration of use or the colour (stabilizers), to simplify the processing (e.g. mould release agents, flow auxiliaries, antistatics) or to adapt the polymer properties to exposure to certain stresses (impact modifiers, such as rubbers; flameproofing agents, colouring agents, glass fibres).

These additives can be added to the polymer melt individually or in any desired mixtures or several different mixtures, and in particular directly during isolation of the polymer or after melting of granules in a so-called compounding step. In this context, the additives or mixtures thereof can be added to the polymer melt as a solid, i.e. as a powder, or as a melt. Another type of metering in is the use of masterbatches or mixtures of masterbatches of the additives or additive mixtures.

Suitable additives are described, for example, in “Additives for Plastics Handbook, John Murphy, Elsevier, Oxford 1999”, or in “Plastics Additives Handbook, Hans Zweifel, Hanser, Munich 2001”.

Preferred heat stabilizers are, for example, organic phosphites, phosphonates and phosphanes, usually those in which the organic radicals consist completely or partly of optionally substituted aromatic radicals. UV stabilizers which are employed are e.g. substituted benzotriazoles. These and other stabilizers can be used individually or in combinations and are added to the polymer in the forms mentioned.

Processing auxiliaries, such as mould release agents, usually derivatives of long-chain fatty acids, can furthermore be added. Pentaerythritol tetrastearate and glycerol monostearate e.g. are preferred. They are employed by themselves or in a mixture, preferably in an amount of from 0.02. to 1 wt. %, based on the weight of the composition.

Suitable flame-retardant additives are phosphate esters, i.e. triphenyl phosphate, resorcinol-diphosphoric acid esters, bromine-containing compounds, such as brominated phosphoric acid esters, brominated oligocarbonates and polycarbonates, and preferably salts of fluorinated organic sulfonic acids.

Suitable impact modifiers are, for example, graft polymers containing one or more graft bases chosen from at least one polybutadiene rubber, acrylate rubber (preferably ethyl or butyl acrylate rubber) and ethylene/propylene rubbers, and grafting monomers chosen from at least one monomer from the group of styrene, acrylonitrile and alkyl methacrylate (preferably methyl methacrylate), or interpenetrating siloxane and acrylate networks with grafted-on methyl methacrylate or styrene/acrylonitrile.

Colouring agents, such as organic dyestuffs or pigments, or inorganic pigments, IR absorbers, individually, in a mixture or also in combination with stabilizers, glass fibres, glass (hollow) beads or inorganic fillers can furthermore be added.

Isolation of carbon nanotubes in the polycarbonate matrix becomes possible with the novel process. However, this composite material can be used further in order to produce isolated polycarbonate-coated carbon nanotubes.

The invention in fact also additionally provides a process for the production of polycarbonate-coated carbon nanotubes, characterized in that the polycarbonate-carbon nanotube composite material obtainable from the novel abovementioned process is dissolved in a solvent, the solution obtained is centrifuged and the polycarbonate-coated carbon nanotubes isolated are separated off from the solution.

In this context, a preferred process is characterized in that the solvent is chosen from the series: methylene chloride, trichloromethane, monochlorobenzene, dichlorobenzene, N-methylpyrrolidone and dimethylformamide, preferably dimethylformamide.

### EXAMPLE

### Starting Substances: (Recipe)

### a) Carbon Nanotubes (CNT)

### Production:

Carbon nanotubes (type Baytubes® CNT WFA 147; manufacturer: Bayer MaterialScience AG) were treated with 65% strength nitric acid under reflux for one hour and then washed with water several times until the wash water was neutral, and were then dried. The carbon nanotubes produced in this way had a quantitative acid functionality of 1 meq. of acid groups per gram of Baytubes® and were employed in the following six concentrations (based on the mixture of polymer+carbon nanotubes):
0.01, 0.1, 1.0, 2.0, 5.0 and 10 wt. %

### b) Polycarbonate (PC)

The polycarbonate component used was poly(Bisphenol-A carbonate) (type Makrolon® 2808; manufacturer Bayer MaterialScience AG).

### c) Transesterification Catalyst

For catalysis of the esterification or transesterification, Ti(IV) butoxide (Ti(OBu)₄, CAS: 5593-70-4) was employed in each case in an amount of 0.1 wt. %, based on the total mixture of polymer+carbon nanotubes+transesterification catalyst.

### Experimental Procedure

The kneader (manufacturer: Haake, type Haake Rheomix R600P) with a counter-rotating twin screw kneading unit and a capacity of 50 ml was preheated to the appropriate starting temperature of 220° C. When the temperature was reached, the kneader was started and a mixture (about 45 g) of polycarbonate, carbon nanotubes and catalyst was added between the rotating kneading hooks from the top via a hopper in the course of 30 s. The speed of rotation of the kneader shafts was 100 rpm.

When addition of the three components (polycarbonate, carbon nanotubes and Ti(OBu)₄) was complete, the time was started. The duration of the reaction, processing and mixing was set at 30 min. Prolonging the reaction time beyond 30 minutes potentially leads to a higher degree of grafting, but at the same time to greater degradation of the polymer. In contrast, a shorter processing time leads to less grafting and less damage to the material.

After the reaction time of 30 minutes, the kneading movement was stopped and the kneader was opened. The composite formed could now be scraped mechanically out of the kneading chamber and from the kneading hooks in the molten state by means of a spatula. The removal process took approx. 10 minutes, during which the product remained in the molten state at the ambient temperature. Optimization of the removal with respect to shorter duration and/or an inert gas atmosphere would still be necessary on a large industrial scale.

After removal, the material cooled naturally to room temperature and could be analysed further in the cooled state.

The transmission electron microscopy (TEM) photographs showed the distribution of the carbon nanotubes in an 80 μm thin section of the nanocomposites from the six experiments. It could be seen that the tubes were distributed exceptionally homogeneously and were present in isolation from one another. Aggregates formed during the production process of the nanotubes were broken down, and the tendency towards formation of new aggregates was successfully prevented. The advantages of nanotechnology can be utilized in an optimum manner.

1-7. (canceled)

8. A process for preparing a conductive carbon nanotube-polycarbonate composite material comprising
(1) treating carbon nanotubes (CNT) with an oxidizing agent to form acid groups on said CNT to obtain an acid-functionalized CNT,
(2) mixing said acid-functionalized CNT with polycarbonate and a transesterification catalyst to obtain a mixture, and
(3) melting and exposing said mixture to shearing forces.

9. The process of claim 8, wherein said oxidizing agent is nitric acid, hydrogen peroxide, potassium permanganate, sulfuric acid, or a mixture thereof.

10. The process of claim 8, wherein said transesterification catalyst is selected from the group consisting of titanium tetrabutanolate, BF₃, AlCl₃, SiCl₄, PF₅, Ti⁴⁺, Cr³⁺, Fe³⁺, Cu²⁺, SiF₄, and Na⁺.

11. The process of claim 8, wherein said mixing, melting, and exposing to shearing forces of the components in steps (2) and (3) take place in one reaction space.

12. The process of claim 8, wherein the exposing to shearing forces in step (3) proceeds at a temperature which is no more than 100° C. above the glass transition temperature of the polycarbonate.

13. The process of claim 8, wherein the exposing to shearing forces in step (3) proceeds at a temperature which is no more than 80° C. above the glass transition temperature of the polycarbonate.

14. A process for producing polycarbonate-coated carbon nanotubes comprising
(A) dissolving the conductive carbon nanotube-polycarbonate composite material obtained from the process of claim 8 in a solvent to obtain a solution,
(B) centrifuging said solution to isolate the polycarbonate-coated carbon nanotubes, and
(C) separating the isolated polycarbonate-coated carbon nanotubes isolated off from the solution.

15. The process of claim 14, wherein said solvent is selected from the group consisting of methylene chloride, trichloromethane, monochlorobenzene, dichlorobenzene, N-methylpyrrolidone, and dimethylformamide.

16. The process of claim 14, wherein said solvent is dimethylformamide.
